(19) United States
(12) Patent Application Publication
(10) Pub. No.: US 2007/0052857 A1
(43) Pub. Date: Mar. 8, 2007

(54) Display driver

(75) Inventors: Min-Seok Song, Seoul (KR); Jong-Seon Kim, Seongnam-si (KR); Jae-Youl Lee, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/512,627

(22) Filed: Aug. 30, 2006

(30) Foreign Application Priority Data
Sep. 8, 2005 (KR) 2005-83545

(51) Int. Cl. H04N 5/45

(52) U.S. Cl. 348/565

(57) ABSTRACT

A display driver includes a first interface controller, a signal selector, a driver logic unit and a second interface controller. The first interface controller processes a control command transferred through a first interface mode to provide a path control command and a panel control command. The signal selector receives the path control command from the first interface controller, and separates a first video signal and a second video signal from a video signal conforming to a video interface mode. The driver logic unit receives the first video signal from the signal selector and the panel control command from the first interface controller to drive a display panel. The second interface controller outputs the second video signal device through a second interface mode to an external.

### CROSS-REFERENCE TO RELATED PATENT APPLICATIONS

This application claims priority to Korean Patent Application No. 2005-83545, filed on Sep. 8, 2005, the contents of which are herein incorporated by reference in their entirety.

### BACKGROUND OF THE INVENTION

1. Technical Field

The present disclosure relates to a display device and, more particularly, to a display driver capable of supporting a multi-display system.

2. Discussion of Related Art

A display device comprising a dual display system includes a main display device and a sub-display device that displays a lesser amount of data than the main display device.

For example, in the case of a folder-type mobile phone, the main display device, which is disposed in the inner side of a folder lid part, functions to display phone numbers at the time of dialing, or an elapsed amount of conversation time during a call. The sub-display device, which is disposed in the outer side of the folder lid part, functions to indicate information including signal reception strength during a standby mode, a clock, a battery level indicator, etc.

A dual display structure offers improved functionality and convenience. However, problems may occur in an interface between a central processing unit and driver circuits driving each display panel.

FIG. 1 is a schematic block diagram illustrating a configuration of a conventional dual display system.

Referring to FIG. 1, the conventional dual display system includes a first display panel 101, a first display driver 102 for driving the first display panel 101, a second display panel 103, a second display driver 104 for driving the second display panel 103, and a processor 105.

As shown in FIG. 1, the first display driver 102 for driving the first display panel 101 is coupled to the processor 105 through a first interface represented by signal line 106, and the second display driver 104 for driving the second display panel 103 is coupled to the processor 105 through a second interface represented by signal line 107.

In the dual display system including a plurality of display drivers, the processor and the display drivers are mainly implemented as an integrated circuit (IC). The processor and the drivers are coupled to each other through distributing wires formed on a printed circuit board (PCB).

Since the processor may operate the plurality of display drivers shown in FIG. 1, the circuitry and wiring coupled to the processor is increased. As a result, the complexity of a system is increased and electromagnetic interference (EMI) characteristics may be deteriorated. Some recent mobile phones include a display for displaying high-resolution video or real-time video received from a built-in camera. Accordingly, data throughputs that the processor has to process have been increased, causing more severe EMI problems. A high-speed serial interface (HSSI) mode that transmits data using a differential interface may be employed. For example, display driver IC chips may incorporate Qualcomm's Mobile Digital Display Interface (MDDI), and Nokia, Inc. has suggested the compact display port (CDP).

When the high-speed serial interface mode is adopted, the circuitry and wiring may be significantly reduced, as compared to when a conventional parallel interface mode is employed. The high-speed serial interface modes that are presently under development include modes used for video synchronization data, as well as other modes used only for data transmission.

The display drivers of conventional dual display devices may not support a high-speed serial interface mode. For example, a main display device may support the high-speed serial interface mode; however, a sub-display device may not support the high-speed serial interface mode.

In the dual display system shown in FIG. 1, the complexity of the wiring and the EMI characteristics may not be effectively improved in a case where the high-speed serial interface mode is adopted.

### SUMMARY OF THE INVENTION

In an exemplary embodiment of the present invention, a display driver includes: a first interface controller configured to process a control command transferred through a first interface mode to provide a path control command and a panel control command; a signal selector configured to receive the path control command from the first interface controller, and configured to separate a first video signal and a second video signal from a video signal conforming to a video interface mode; a driver logic unit configured to receive the first video signal from the signal selector and the panel control command from the first interface controller to drive a display panel; and a second interface controller configured to output the second video signal through a second interface mode to an external device.

In an exemplary embodiment of the present invention, a display driver includes: a first interface controller configured to receive an input video signal and a control command through a first interface mode, configured to process the control command to provide a path control command and a panel control command, and configured to convert the input video signal to a video signal conforming to a video interface mode, the video signal including video synchronization data; a signal selector configured to receive the path control command and the video signal from the first interface controller, and configured to separate a first video signal and a second video signal from the video signal; a driver logic unit configured to receive the first video signal from the signal selector and the panel control command from the first interface controller to drive a display panel; and a second interface controller configured to output the second video signal through a second interface mode to an external device.

In an exemplary embodiment of the present invention, a display driver includes: a first interface controller configured to process a control command transferred through a first interface mode to provide a path control command and a panel control command; a first signal selector configured to receive the path control command from the first interface controller, and configured to separate a first video signal and a second video signal from a video signal conforming to a video interface mode; a second signal selector configured to receive the path control command and the panel control command from the first interface controller, and configured to separate a first panel control command and a second panel control command from the path control command; a driver logic unit configured to receive the first video signal and the first panel control command to drive a display panel; and a second interface controller configured to output the second video signal and the second panel control command through a second interface mode to an external device.

In an exemplary embodiment of the present invention, a display driver includes: a first interface controller configured to receive an input video signal and a control command through a first interface mode, configured to process the control command to provide a path control command and a panel control command, and configured to convert the input video signal to a video signal conforming to a video interface mode, the video signal including video synchronization data; a first signal selector configured to receive the path control command and the video signal from the first interface controller, and configured to separate a first video signal and a second video signal from the video signal; a second signal selector configured to receive the path control command and the panel control command from the first interface controller, and configured to separate a first panel control command and a second panel control command from the panel control command; a driver logic unit configured to receive the first video signal and the first panel control command to drive a display panel; and a second interface controller configured to output the second video signal and the second panel control command through a second interface mode to an external device.

In an exemplary embodiment of the present invention, a display device includes: a display panel; a first interface controller configured to process a control command transferred through a first interface mode to provide a path control command and a panel control command; a signal selector configured to receive the path control command from the first interface controller, and configured to separate a first video signal and a second video signal from a video signal transferred through a video interface mode; a driver logic unit configured to receive the first video signal from the signal selector and the panel control command from the first interface controller to drive the display panel; and a second interface controller configured to output the second video signal through a second interface to an external device.

In an exemplary embodiment of the present invention, a display device includes: a display panel; a first interface controller configured to receive an input video signal and a control command through a first interface mode, configured to process the control command to provide a path control command and a panel control command, and configured to convert the input video signal to a video signal conforming to a video interface mode, the video signal including video synchronization data; a signal selector configured to receive a path control command and the video signal from the first interface controller, and configured to separate a first video signal and a second video signal from the converted video signal; a driver logic unit configured to receive the first video signal to drive the display panel using the first video signal; and a second interface controller configured to output the second video signal through a second interface mode to an external device.

In an exemplary embodiment of the present invention, a display device includes: a display panel; a first interface controller configured to process a control command transferred through a first interface mode to provide a path control command and a panel control command; a first signal selector configured to receive the path control command from the first interface controller, and configured to separate a first video signal and a second video signal from a video signal conforming to a video interface mode; a second signal selector configured to receive the path control command and the panel control command from the first interface controller, and configured to separate a first panel control command and a second panel control command from the panel control command; a driver logic unit configured to receive the first video signal and the first panel control command to drive the display panel; and a second interface controller configured to output the second video signal and the second panel control command through a second interface mode to an external device.

In an exemplary embodiment of the present invention, a display device includes: a display panel; a first interface controller configured to receive an input video signal and a control command through a first interface mode, configured to process the control command to provide a path control command and a panel control command, and configured to convert the input video signal to a video signal conforming to a video interface mode, the video signal including video synchronization data; a first signal selector configured to receive the path control command and the video signal from the first interface controller, and configured to separate a first video signal and a second video signal from the converted video signal; a second signal selector configured to receive the path control command and the panel control command from the first interface controller, and configured to separate a first panel control command and a second panel control command from the panel control command; a driver logic unit configured to receive the first video signal the first panel control command to drive the display panel; and a second interface controller configured to output the second video signal and the second panel control command through a second interface mode to an external device.

In an exemplary embodiment of the present invention, a display system includes: a processor configured to provide a video signal including video synchronization data, and a control command; a first display device configured to process the control command to separate a first video signal and a second video signal from the video signal, configured to display a first video image based on the first video signal, and configured to provide the second video signal through a video interface mode; and a second display device configured to display a second video image based on the second video signal received from the first display device.

In an exemplary embodiment of the present invention, a display system includes: a processor configured to provide a video signal including video synchronization data, and a control command; a first display device configured to process the control command to separate a first video signal and a second video signal from the video signal, configured to display a first video image based on the first video signal and the control command corresponding to the first video signal, configured to provide the control command corresponding to the second video signal during a vertical blanking interval of the second video signal, and configured to provide the second video signal to the second display device through a video interface mode; and a second display device configured to display a second video image based on the second video signal and the control command received from the first display device.

### BRIEF DESCRIPTION OF THE DRAWINGS

The present invention will become readily apparent to those of ordinary skill in the art when descriptions of exemplary embodiments thereof are read with reference to the accompanying drawings.

FIG. 1 is a schematic block diagram illustrating a configuration of a conventional display system.

FIG. 2 is a schematic block diagram illustrating a configuration of a display system according to an exemplary embodiment of the present invention.

FIG. 3 is a block diagram illustrating a configuration of a display system according to an exemplary embodiment of the present invention.

FIG. 4 is a block diagram illustrating a configuration of a first display driver according to an exemplary embodiment of the present invention.

FIG. 5 is a waveform diagram illustrating signals used in a serial peripheral interface (SPI) according to an exemplary embodiment of the present invention.

FIGS. 6 and 7 are waveform diagrams for explaining operations of a display driver according to an exemplary embodiment of the present invention.

FIG. 8 is a block diagram illustrating a configuration of a display system according to an exemplary embodiment of the present invention.

FIG. 9 is a block diagram illustrating a configuration of a first display driver according to an exemplary embodiment of the present invention.

FIG. 10 is a block diagram illustrating a configuration of a display system according to an exemplary embodiment of the present invention.

FIG. 11 is a block diagram illustrating a configuration of a display system according to an exemplary embodiment of the present invention.

FIG. 12 is a block diagram illustrating a configuration of a display system according to an exemplary embodiment of the present invention.

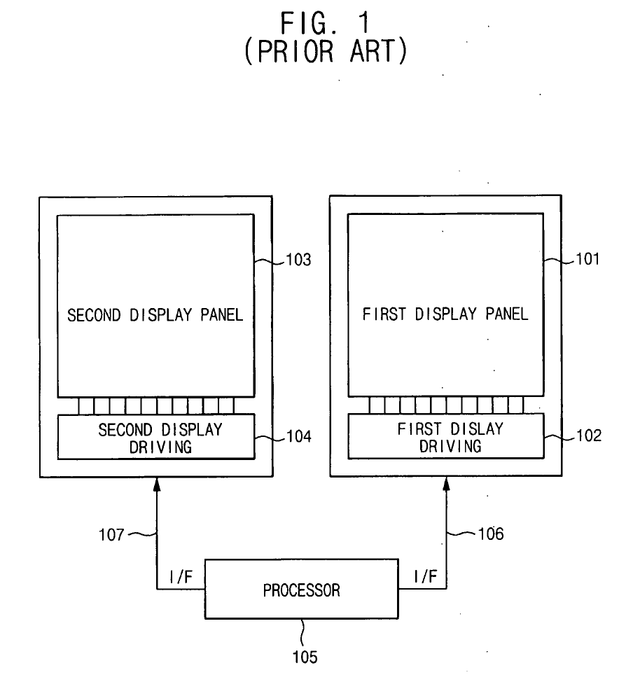

### DESCRIPTION OF EXEMPLARY EMBODIMENTS

Hereinafter, exemplary embodiments of the present invention will be described with reference to the accompanying drawings. Like reference numerals refer to similar or identical elements throughout the description of the figures.

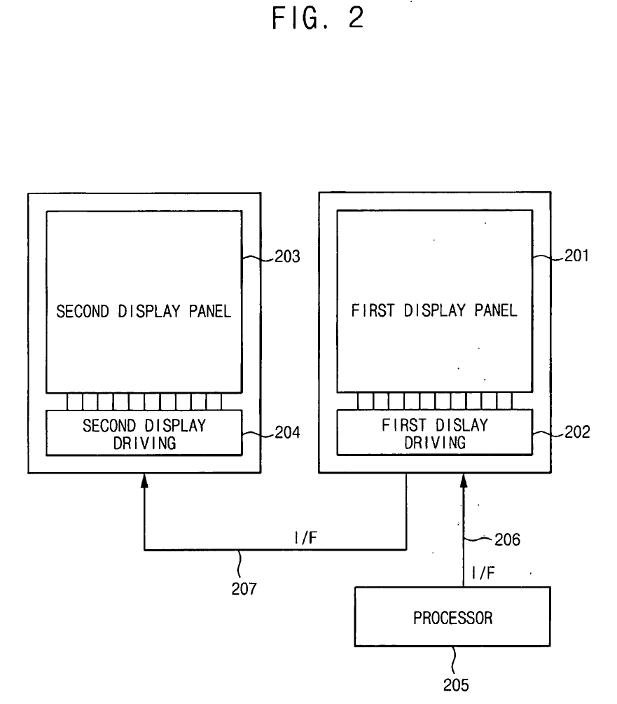

FIG. 2 is a schematic block diagram illustrating a configuration of a display system according to an exemplary embodiment of the present invention.

Referring to FIG. 2, the display system includes a first display panel 201, a first display driver 202 for driving the first display panel 201, a second display panel 203, a second display driver 204 for driving the second display panel 203, and a processor 205.

For example, in a case where the display system shown in FIG. 2 is a mobile phone, a baseband modem chip, such as Qualcomm's Mobile Station Modem (MSM) chip, or a microprocessor unit (MPU) may function as the processor 205.

The first display driver 202 may support two or more interfaces represented by signal lines 206 and 207. The first display driver 202 receives a video signal, which may include a first video signal and a second video signal, from an external device through the first interface. The first display driver 202 separates the first video signal and the second video signal from the received video signal.

The first display driver 202 drives the first display panel 201 in response to the first video signal, and transfers the second video signal through the second interface 207 to the second display driver 204. For example, the first video signal represents a signal that is used by the first display driver 202 to drive the first display panel 201, and the second video signal represents a signal used by the second display driver 204 to drive the second display panel 203.

In an exemplary embodiment of the present invention, the first interface 206 comprises a video interface. The video interface may be also referred to as a red-green-blue (RGB) interface, since the video signal may include an RGB data signal. The video signal may further include a horizontal synchronization signal, a vertical synchronization signal, a data enable signal and a clock signal. Video synchronization data, such as the horizontal synchronization signal and the vertical synchronization signal, includes timing information required when a display device displays a video image.

In an exemplary embodiment of the present invention, the first interface 206 comprises a high-speed serial interface for transmission of the video signal including the video synchronization data. The video synchronization data may be used for obtaining timing information needed when the first display panel 201 outputs a video image, and timing information needed when the second display panel 203 outputs a video image.

When the processor 205 provides the video signal to the first display driver 202, the first video signal and the second video signal that are included in the video signal may be sequentially transferred to the first display driver 202 or may be substantially simultaneously transferred to the first display driver 202. For example, in a case where the first interface 206 comprises a video interface, the first video signal and the second video signal may be selectively transferred to the first display driver 202. In a case where the first interface 206 comprises a packet type interface, the first video signal and the second video signal may be substantially simultaneously transferred to the first display driver 202.

The second interface 207 may be used when the first display driver 202 transfers the second video signal to another display device, such as for example, the second display driver 204.

In an exemplary embodiment of the present invention, the second interface 207 comprises an MPU interface. For example, an MPU interface such as an 80-mode parallel interface may be employed. An MPU interface such as a Motorola 68000 series interface may be employed.

In an exemplary embodiment of the present invention, the second interface 207 comprises a video interface. The MPU interface may be used for transferring data and control commands. The MPU interface may not be suitable for transferring the video synchronization data. When both the first display panel 201 and the second display panel 203 output a video image, the video synchronization data may be required.

For example, when the second interface 207 comprises a video interface, the first display driver 202 transfers the second video signal including the video synchronization data to the second display driver 204. However, when the second interface 207 comprises an MPU interface, the first display driver 202 transfers the second video signal (pixel data values) having no video synchronization data to the second display driver 204. At this time, the first display driver 202 outputs the second video signal to the second display driver 204 in synchronization with the first video signal.

The second display panel 203 may have a lower resolution and a lower color depth as compared with the first display panel 201. In such a case, the MPU interface having a lower speed and a parallel interface compared with the first interface 206 may be employed as the second interface 207. It is to be understood that various other interfaces having functions substantially equivalent to the first interface 206 or having performance better than the first interface 206 may be employed as the second interface 207.

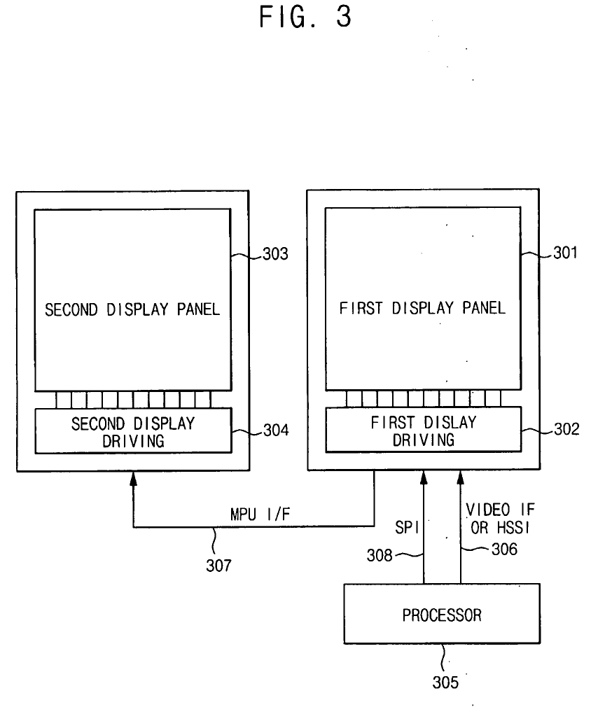

FIG. 3 is a block diagram illustrating a configuration of a display system according to an exemplary embodiment of the present invention.

Referring to FIG. 3, the display system includes a first display panel 301, a first display driver 302 for driving the first display panel 301, a second display panel 303, a second display driver 304 for driving the second display panel 303, and a processor 305.

The processor 305 transfers a video signal for the first display panel 301 and the second display panel 303 to the first display driver 302 through a video interface or a high-speed serial interface including video synchronization data. In case of a video interface, the video interface does not transfer control commands to the first display driver 302, and the processor 305 transfers the control commands for controlling the first display driver 302 and the second display driver 304 through an extra interface 308 to the first display driver 302.

In an exemplary embodiment of the present invention, the extra interface 308 between the processor 305 and the first display driver 302 may be implemented with a serial peripheral interface (SPI). For example, the first interface 206 shown in FIG. 2 includes the video/high-speed serial interface (HSSI) 306 and the SPI interface 308.

The first display driver 302 separates the video signal transferred from the processor 305 into a first video signal and a second video signal. The first display driver 302 drives the first display panel 301 using the first video signal and the first display driver 302 transfers the second video signal to the second display driver 304. In an exemplary embodiment of the present invention, the first display driver 302 separates the video signal into the first video signal and the second video signal using the control commands transferred through the SPI interface 308.

The second display driver 304 receives -the second video signal transferred from the first display driver 302 through the MPU interface 307. The MPU interface 307 transfers the video data, for example, RGB data; however, the MPU interface 307 does not transfer the video synchronization data including a horizontal synchronization signal and a vertical synchronization signal. In an exemplary embodiment of the present invention, the first display driver 302 transfers the second video signal to the second display driver 304 based on the video synchronization data corresponding to the second video signal, which is provided from the processor 305.

When the processor 305 transfers the control command for controlling the second display driver 304 to the first display driver 302 through the SPI interface 308, the first display driver 302 transfers the control command through the MPU interface 307 to the second display driver 304. In an exemplary embodiment of the present invention, the first display driver 302 selects timing for transferring the control command to the second display driver 304 using the video synchronization data.

When the first interface 306 comprises a high-speed serial interface, the high-speed serial interface including the video synchronization data may transfer data such as the control command. In such a case, the extra interface, the SPI interface 308 for transferring the control commands may be omitted. For example, when the first interface 306 comprises a serial communication interface capable of transferring both the video data and the video synchronization data, the processor 305 transfers the video signal and the control command through the first interface 306.

The first display panel 301 displays a first video image under control of the first display driver 302 and the second display panel 303 outputs a second video image under control of the second display driver 304.

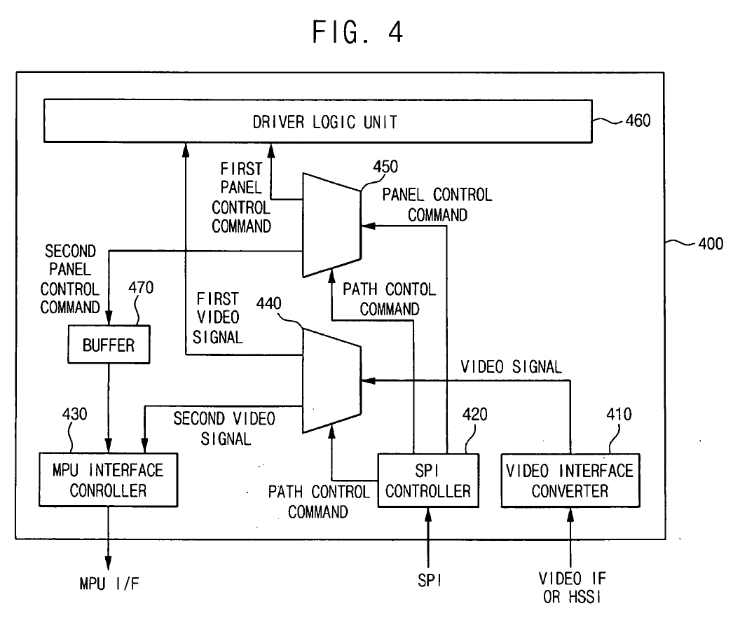

FIG. 4 is a block diagram illustrating a configuration of a first display driver according to an exemplary embodiment of the present invention.

Referring to FIG. 4, the first display driver 400 includes an SPI controller 420, a first signal selector 440, a second signal selector 450, an MPU interface controller 430 and a driver logic unit 460. The first display driver 400 may include a video interface converter 410 and a buffer 470.

When the SPI controller 420 receives a control command in SPI mode, the SPI controller 420 determines whether the control command comprises a panel control command, or a path control command for controlling each path of a video signal or a panel control command. When the control command comprises the path control command, the SPI controller 420 provides the path control command to the first signal selector 440 and the second signal selector 450. When the control command comprises the panel control command, the SPI controller 420 provides the panel control command to the second signal selector 450.

The first signal selector 440 receives the video signal and separates the received video signal into a first video signal corresponding to a first display panel 301 shown in FIG. 3, and a second video signal corresponding to a second display panel 303 shown in FIG. 3. That is, the first signal selector 440 selects the first video signal and the second video signal from the video signal based on the path control command provided from the SPI controller 420. The first video signal may be a signal that is provided to the driver logic unit 460, and the second video signal may be a signal that is provided to an external device of the first display driver 400, such as for example, a second display driver 304 shown in FIG. 3. The first signal selector 440 provides the first video signal to the driver logic unit 460 and provides the second video signal to the MPU interface controller 430.

The second signal selector 450 separates the panel control command into a first panel control command, corresponding to the first display panel 301 shown in FIG. 3, and a second panel control command corresponding to the second display panel 303 shown in FIG. 3. The second signal selector 450 provides the first panel control command to the driver logic unit 60 and provides the second panel control command to the MPU interface controller 430. For example, the first panel control command is provided to the driver logic unit 460, and the second panel control command is provided to the external device of the first display driver 400, such as for example, the second display driver 304 shown in FIG. 3.

The first display driver 400 may include a buffer 470 for temporarily storing the second panel control command so as to control a transmission time of the second panel control command.

The MPU interface controller 430 receives the second video signal from the first signal selector 440 and the second panel control command from the buffer 470 to generate the second video signal and the second panel control command corresponding to the MPU interface. The MPU interface controller 430 transfers the second video signal and the second panel control command through the MPU interface to another display device, such as for example, the second display driver 304 shown in FIG. 3.

In an exemplary embodiment of the present invention, the MPU interface controller 430 may transfer the second video signal and the second panel control command through an 80-mode MPU interface.

The MPU interface controller 430 may transfer the second video signal and the second panel control command through a 68-mode MPU interface. It is to be understood that the second video signal and the second panel control command may be transferred through other MPU interfaces.

The driver logic unit 460 receives the first video signal of the video interface mode to obtain pixel data of the first display panel (not shown) from the first video signal, and allows the first display panel (not shown) to output a video image based on the horizontal synchronization signal HSYNC and the vertical synchronization signal VSYNC. The driver logic unit 460 controls the first display panel (not shown) based on the first panel control command.

The first display driver 400 may include a video interface converter 410 for converting the video signal conforming to the high-speed serial interface into the video signal conforming to the video interface when the video signal is not received through the video interface. For example, when the video signal is received through the high-speed serial interface that includes video synchronization data, the video interface converter 410 converts the high-speed serial interface video signal including the video synchronization data into the video signal conforming to the video interface, and then the video interface converter 410 outputs the video signal corresponding to the video interface to the first signal selector 440.

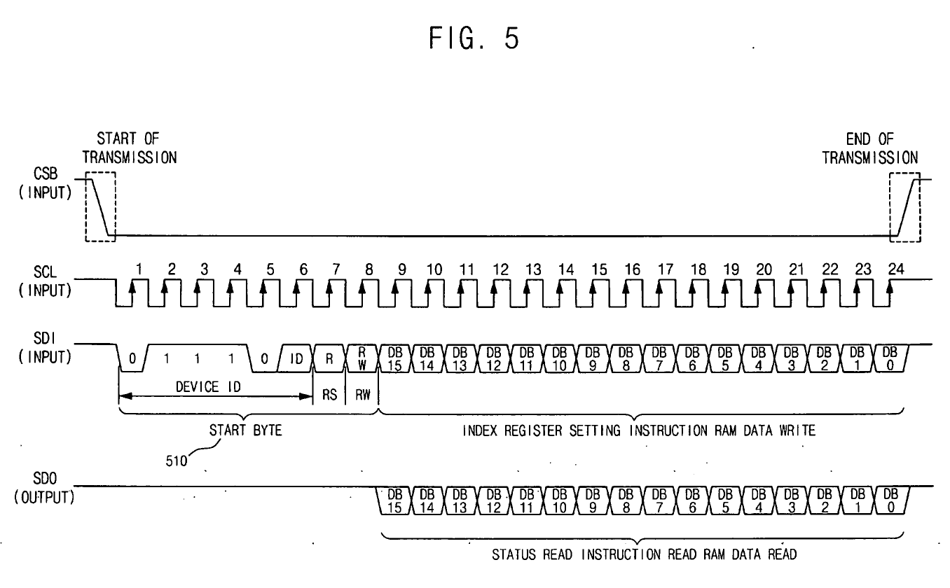

Hereinafter, a procedure for determining each path using SPI signals and operations of the display driver will be explained with reference to FIG. 5.

FIG. 5 is a waveform diagram illustrating signals used in an SPI according to an exemplary embodiment of the present invention.

Referring to FIG. 5, the signals used in the SPI include a CSB signal, a SCL signal, a SDI signal and a SDO signal.

The CSB signal is a low enable signal, and when the CSB signal becomes a “low” level, data may be transferred according to the SPI mode. The SCL signal is a system clock signal, and the data is transferred in response to a rising edge or a falling edge of the system clock signal. The SDI signal refers to a data signal transferred from a host to a slave, and is composed of a start byte corresponding to a header and data that are serially transferred. The SDO signal refers to a data signal transferred from the slave to the host.

In an exemplary embodiment of the present invention, the processor comprises the host, and the display driver comprises the slave. Both the processor and the display driver may perform a function as the host and the slave, respectively.

When the CSB signal becomes a “low” level, the processor transfers the control command to the display driver, and the processor transfers the SDI signal including the control command to the display driver. The control command includes a start byte 510 corresponding to a header of the control command and 16-bit data used for setting an index register included in the display driver.

The start byte 510 begins with ‘01110’, and an ID bit 520 follows the start byte 510. An RS bit and an RW bit follow the ID bit 520, and the RS bit is used for determining whether the transferred data is video data or command data. For example, a command write operation is performed when the RS bit value is equal to “0”, and a data write operation is performed when the RS bit value is equal to “1”. The RW bit is used for determining whether data (command or video data) are written to the display driver from the processor or the data is transferred to the processor from the display driver.

In an exemplary embodiment of the present invention, a target display driver is selected based on a value of the ID bit 520. In a display system according to an exemplary embodiment of the present invention described in connection with FIG. 3, for example, the control command may be transferred to the first display driver 302 when the value of the ID bit 520 is equal to “0”, and the control command may be transferred to the second display driver 304 when the value of the ID bit 520 is equal to “1”. The control command may be transferred to the second display driver 304 when the value of the ID bit 520 is equal to “0”, and the control command may be transferred to the first display driver 302 when the value of the ID bit 520 is equal to “1”.

The second display driver 304 may determine a path of the control command and a path of the video signal based on the value of the ID bit 520 included in the start byte 510 of the control command transferred through the SPI. The second display driver 304 may determine each path of the control command and the video signal by setting the data values after the start byte 510.

Referring to FIG. 4, the SPI controller 420 interprets the control command transferred through the SPI. When the path instructed by the control command is determined as the first display driver, the video signal (the first video signal) and the panel control command (the first panel control command) are transferred to the driver logic unit 460. On the contrary, when the path instructed by the control command is determined as the second display driver, the video signal (the second video signal) and the panel control command (the second panel control command) are transferred to the MPU interface controller 430.

The MPU interface controller 430 transfers the second video signal and the second panel control command through the MPU interface to the second display driver. When the path of the video signal is determined, an internal register value of the first signal selector 440 is differently set based on the value of the ID bit 520; thus, the first video signal and the second video signal may be separated from the video signal. Similar to the separation of the video signal, the control command may be separated into the first panel control command and the second panel control command.

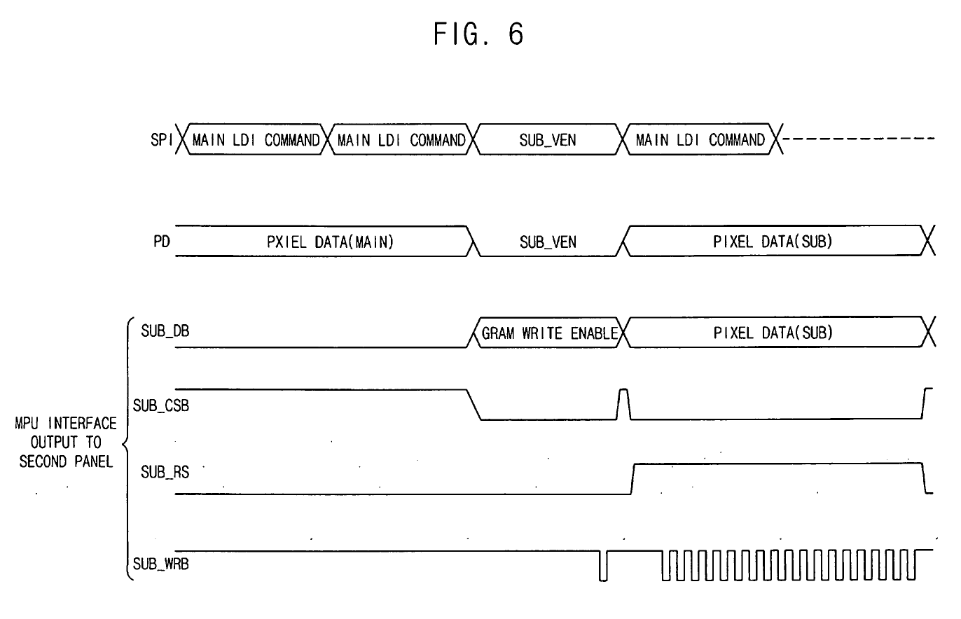

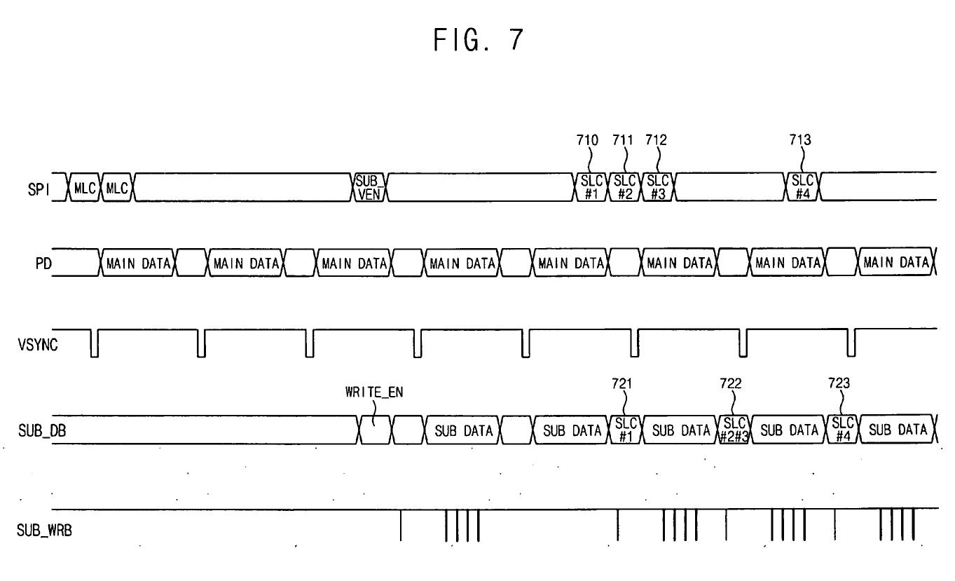

FIGS. 6 and 7 are waveform diagrams for explaining operations of a display driver according to an exemplary embodiment of the present invention.

In FIG. 6, “Main LDI” (LCD Driver IC) corresponds to the first display driver, and “Sub LDI” corresponds to the second display driver. An “SPI” signal refers to a signal including the SPI control command received by the LDI, a “PD” signal means a data bus signal of the video interface and the PD signal is used for transferring pixel data of the video signal.

A “Sub_DB” signal refers to a data bus signal of the MPU interface, and a “Sub_CSB” signal refers to a signal for determining whether or not the Sub LDI is activated. A “Sub_RS” signal refers to a signal for distinguishing between the control command and the video data, and a “Sub_WRB” signal refers to a signal for notifying whether or not a write operation is possible.

The Main LDI receives the control command and the video signal through the SPI signal and the PD signal, and may transfer the control command and the video signal to the Sub LDI using the Sub_DB signal, the Sub_CSB signal, the Sub_RS signal and the SubWRB signal.

When a “SUB_VEN” register bit of an internal register included in the Main LDI is set to a “high” level, the second video signal transferred through the video interface is converted to the second video signal corresponding to an MPU interface format. The converted second video signal is transferred to the Sub LDI. To write the second video signal to the Sub LDI, a Graphic Random Access Memory (GRAM) write enable signal has to be firstly transferred. Accordingly, when the SUB_VEN register bit is set to a “high” level, the Main LDI transfers the GRAM write enable signal to the Sub LDI through the MPU interface and then the Main LDI transfers the second video signal through the MPU interface to the Sub LDI.

When the control command to be transferred to the Sub LDI is inputted through the SPI while the Main LDI transfers the second video signal to the Sub LDI, the Main LDI does not directly transfer the control command to the Sub LDI. The Main LDI transfers the control command in synchronization with the second video signal, because there may be a possibility of loss on a portion of the second video signal required for the Sub panel driven by the Sub LDI when the control command is transferred to the Sub LDI while the Main LDI transfers the second video signal to the Sub LDI.

FIG. 7 shows a method of preventing the loss on a portion of the second video signal. In the interests of clarity and simplicity, it will be assumed that video synchronizations of the main panel and the sub panel are substantially identical to each other.

The Main LDI receives the control commands through the SPI. In FIG. 7, “MLC” designates a Main LDI command, and “SLC” designates a Sub LDI command. The Main LDI receives the PD signal including the video signal through the video interface. Additionally, the Main LDI receives video synchronization data. The Main LDI uses the first video signal (main data) received through the PD signal to drive the main panel. The Main LDI transfers the second video signal (sub data) received through the PD signal to the Sub LDI.

When the Main LDI receives the Sub LDI commands 710, 711, 712 and 713 included in the SPI signal, the Main LDI, which does not directly transfer the Sub LDI commands 710, 711, 712 and 713 to the Sub LDI, transfers the Sub LDI commands 710, 711, 712 and 713 corresponding to the video synchronization data. As illustrated in FIG. 7, the Main LDI transfers the Sub LDI commands 720, 721, 722 and 723 through the MPU interface to the Sub LDI at each vertical blanking interval when a vertical synchronization signal VSYNC falls to a “low” level.

In a case where a transmission speed of the MPU interface is high, the Main LDI may transfer the Sub LDI commands 720, 721, 722 and 723 through the MPU interface to the Sub LDI at each horizontal blanking interval when a horizontal synchronization signal HSYNC falls to a “low” level. In such a case, the Main LDI determines timing for transferring the Sub LDI commands based on the horizontal synchronization signal. The buffer 470 shown in FIG. 4 temporarily stores the Sub LDI commands until a transmission time.

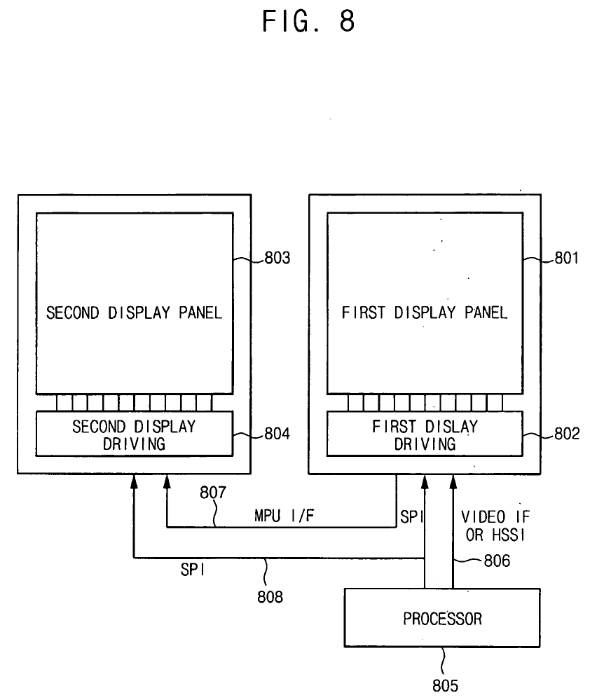

FIG. 8 is a block diagram illustrating a configuration of a display system according to an exemplary embodiment of the present invention.

Referring to FIG. 8, the display system includes a first display panel 801, a first display driver 802 for driving the first display panel 801, a second display panel 803, a second display driver 804 for driving the second display panel 803, and a processor 805.

The processor 805 transfers a video signal for the first display panel 801 and the second display panel 803 to the first display driver 802 through the video interface or the high-speed serial interface 806 including video synchronization data. In case of a video interface, the processor 805 transfers the control commands for controlling the first and second display drivers 802 and 804 to the first display driver 802 and the second display driver 804, respectively, through an extra interface 808, since the video interface may not transfer control commands.

In an exemplary embodiment of the present invention, the processor 805 transfers the control commands through the SPI 808 to the first display driver 802 and the second display driver 804. Considering electromagnetic interference (EMI) characteristics, the processor 805 transfers the control commands for controlling both the first display driver 802 and the second display driver 804 through the single SPI 808 to the first display driver 802 and the second display driver 804. The first display driver 802 and the second display driver 804 interpret the control command to determine a path of the control command. For example, when the value of the ID bit is equal to “0”, the first display driver 802 performs an operation corresponding to the control command, and when the value of the ID bit is equal to “1”, the second display driver 804 performs an operation corresponding to the control command.

However, although the value of the ID bit is equal to “1”, the first display driver 802 may perform the operation corresponding to the control command. For example, when the control command for turning on the second display driver 804 is transferred through the SPI 808, the first display driver 802 transfers the video synchronization data, including the vertical synchronization signal, horizontal synchronization signal, clock and data enable signals, through the video interface 807 to the second display driver 804.

Based on a data enable signal, a video data port is fixed so as to prevent abnormal operation in some regions where data is not valid. Although the value of the ID bit is equal to “1”, when the control command for controlling a video data write operation is transferred through the SPI 808 to the second display driver 804, the first display driver 802 may transfer the video synchronization data and the video data through the video interface 807 to the second display driver 804.

The first display driver 802 separates the first video signal and the second video signal from the video signal transferred from the processor 805. The first display driver 802 drives the first display panel 801 using the first video signal, and transfers the second video signal to the second display driver 804. In an exemplary embodiment of the present invention, the first display driver 802 separates the first video signal and the second video signal from the video signal using the control commands transferred through the SPI 808.

The second display driver 804 receives the second video signal transferred from the first display driver 805 through the video interface 807. That is, the second video signal may include both the video synchronization data and the video data.

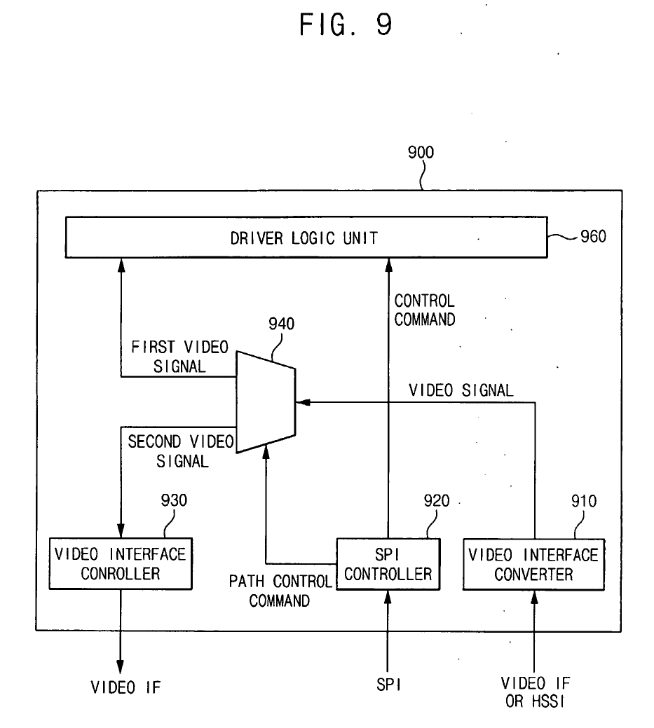

A display driver capable of driving a plurality of the display devices that supports both the video interface and the SPI according to an exemplary embodiment of the present invention will be described with reference to FIG. 9.

FIG. 9 is a block diagram illustrating a configuration of a first display driver according to an exemplary embodiment of the present invention.

Referring to FIG. 9, the first display driver 900 includes an SPI controller 920, a signal selector 940, a video interface controller 930 and a driver logic unit 960.

The SPI controller 920 receives a control command through the SPI to interpret whether the control command comprises a panel control command or a path control command used for controlling a path of a video signal. When the control command comprises the path control command, the SPI controller 920 provides the control command to the signal selector 940. When the control command comprises the panel control command, the SPI controller 920 provides the control command to the driver logic unit 960.

The signal selector 940 receives the video signal to separate a first video signal and a second video signal from the video signal. To separate the first video signal and the second video signal from the video signal, the signal selector 940 uses the path control command from the SPI controller 920. The signal selector 940 provides the first video signal to the driver logic unit 960, and provides the second video signal to the video interface controller 930.

The video interface controller 930 transfers the second video signal through the video interface to another display device, for example, the second display driver (not shown). The second video signal transferred through the video interface includes the video synchronization data and the video data.

The driver logic unit 960 receives the first video signal of the video interface to obtain pixel data of the first display panel (not shown) from the first video signal, and allows the first display panel (not shown) to output a video image in synchronization with the horizontal synchronization signal and the vertical synchronization signal. The driver logic unit 960 controls the first display panel (not shown) based on the panel control command.

The first display driver 900 may include a video interface converter 910. When the video signal is not provided through the video interface, the first display driver 900 may convert the video signal of another interface to the video signal of the video interface using the video interface converter 910. For example, when the video signal is provided through the high-speed serial interface including the video synchronization data, the video interface converter 910 converts the video signal including the video synchronization data into the video signal of the video interface and then outputs the video signal of the video interface to the signal selector 940.

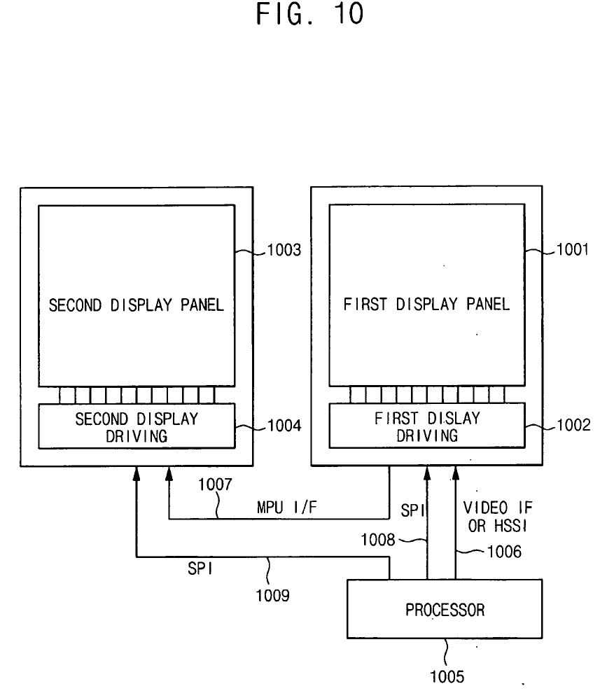

FIG. 10 is a block diagram illustrating a configuration of a display system according to an exemplary embodiment of the present invention.

In the display system shown in FIG. 10, a processor 1005 transfers a video signal through a single interface 1006, for example, similarly to the processor 805 according to the exemplary embodiment of the present invention described in connection with FIG. 8. In addition, the processor 1005 may separately transfer a control command to a first display driver 1002 and a second display driver 1004 through different wires:

When the processor 1005 transfers the video signal to the first display driver 1002 through the video interface or the high-speed serial interface including the video synchronization data, the first display driver 1002 separates a first video signal and a second video signal from the video signal. To separate the first video signal and the second video signal from the video signal, the first display driver 1002 uses the control command transferred through a first SPI 1008.

The first display driver 1002 drives a first display panel 1001 using the first video signal and transfers the second video signal to the second display driver 1004. The second display driver 1004. drives a second display panel 1003 using the second video signal. The second display driver 1004 controls the second display panel 1003 based on the control command transferred through a second SPI 1009.

Hereinafter, display device including three or more display devices according to exemplary embodiments of the present invention will be described.

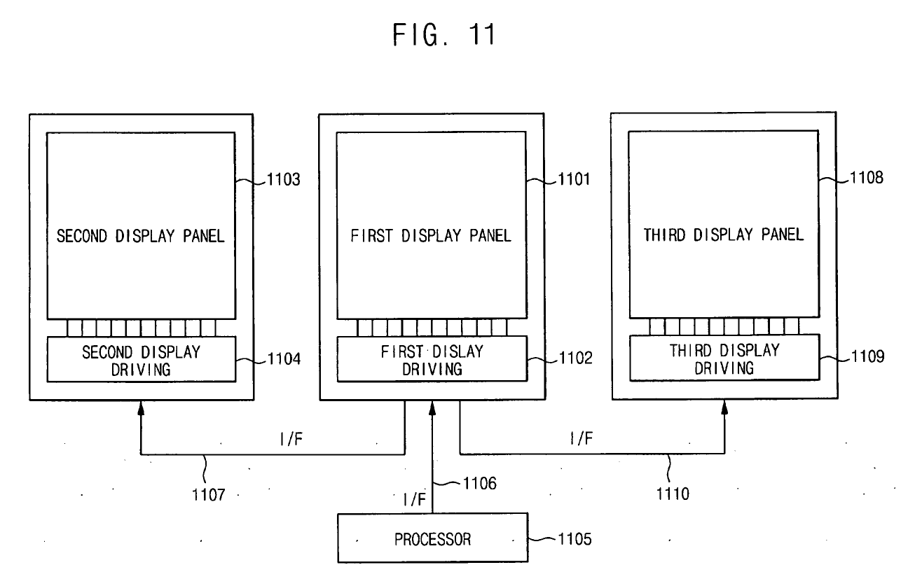

FIG. 11 is a block diagram illustrating a configuration of a display system according to an exemplary embodiment of the present invention.

Referring to FIG. 11, the processor 1105 transfers all video signals to be output to a first display panel 1101, a second display panel 1103 and a third display panel 1108 through a first interface represented by signal line 1106 to the first display driver 1102, including video synchronization data.

The first display driver 1102 separates a first video signal, a second video signal and a third video signal from the video signal and then, transfers the second video signal through a second interface represented by signal line 1107 to the second display driver 1104 and transfers the third video signal through a third interface represented by signal line 1110 to the third display driver 1109.

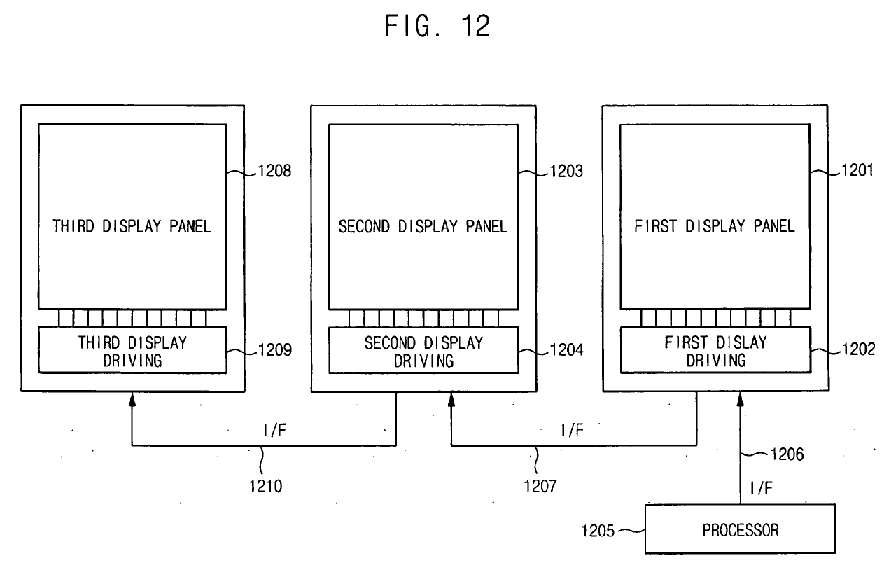

FIG. 12 is a block diagram illustrating a configuration of a display system according to an exemplary embodiment of the present invention.

Referring to FIG. 12, a processor 1205 transfers all video signals to be output to a first display panel 1201, a second display panel 1203 and a third display panel 1208 through a first interface represented by signal line 1206 to the first display driver 1202, including video synchronization data.

The first display driver 1202 separates a first video signal, a second video signal and a third video signal from the video signal and then, transfers the second video signal for a second display panel 1203 and the third video signal for a third display panel 1204 through a second interface represented by signal line 1207 to the second display driver 1204. The second display driver 1204 transfers the third video signal for the third display panel 1208 through a third interface represented by signal line 1210 to the third display driver 1209.

Display systems employing the display driver according to exemplary embodiments of the present invention may reduce wiring complexity by transmitting/receiving video signals between display devices. Display systems using the display driver according to exemplary embodiments of the present invention may improve EMI characteristics. The display driver according to exemplary embodiments of the present invention may control timing for transferring video signals and control commands corresponding to other display devices by receiving the video signal through an interface, including the video synchronization data.

Although the exemplary embodiments of embodiments of the present invention have been described in detail with reference to the accompanying drawings for the purpose of illustration, it is to be understood that the inventive processes and apparatus should not be construed as limited thereby. It will be readily apparent to those of reasonable skill in the art that various modifications to the foregoing exemplary embodiments may be made without departing from the scope of the invention as defined by the appended claims, with equivalents of the claims to be included therein.

What is claimed is:

1. A display driver comprising:
a first interface controller configured to process a control command transferred through a first interface mode to provide a path control command and a panel control command;
a signal selector configured to receive the path control command from the first interface controller, and configured to separate a first video signal and a second video signal from a video signal conforming to a video interface mode;
a driver logic unit configured to receive the first video signal from the signal selector and the panel control command from the first interface controller to drive a display panel; and
a second interface controller configured to output the second video signal through a second interface mode to an external device.

2. The display driver of claim 1, wherein the first interface controller provides the panel control command to the driver logic unit when the control command comprises the panel control command for controlling the driver logic unit, and wherein the first interface controller is configured to enable the second interface controller to output the second video signal when the control command comprises the path control command for controlling an output of the second video signal.

3. The display driver of claim 2, wherein the second interface mode comprises the video interface mode.

4. The display driver of claim 1, further comprising a video interface converter configured to convert a signal received through a third interface mode including video synchronization data to the video signal conforming to the video interface mode.

5. The display driver of claim 4, wherein the third interface mode comprises a high-speed serial interface mode including the video synchronization data.

6. The display driver of claim 1, wherein the first interface mode comprises a serial peripheral interface (SPI) mode.

7. The display driver of claim 6, wherein the first interface controller processes the control command based on an identifier of an SPI header.

8. A display driver comprising:
a first interface controller configured to receive an input video signal and a control command through a first interface mode, configured to process the control command to provide a path control command and a panel control command, and configured to convert the input video signal to a video signal conforming to a video interface mode, the video signal including video synchronization data;
a signal selector configured to receive the path control command and the video signal from the first interface controller, and configured to separate a first video signal and a second video signal from the video signal;
a driver logic unit configured to receive the first video signal from the signal selector and the panel control command from the first interface controller to drive a display panel; and
a second interface controller configured to output the second video signal through a second interface mode to an external device.

9. The display driver of claim 8, wherein the first interface controller provides the control command to the driver logic unit when the control command comprises the panel control command for controlling the driver logic unit, and configured to enable the second interface controller to output the second video signal when the control command comprises the path control command for controlling an output of the second video signal.

10. The display driver of claim 9, wherein the second interface mode comprises the video interface mode.

11. The display driver of claim 8, wherein the first interface mode comprises a high-speed serial interface mode including video synchronization data.

12. A display driver comprising:
a first interface controller configured to process a control command transferred through a first interface mode to provide a path control command and a panel control command;
a first signal selector configured to receive the path control command from the first interface controller, and configured to separate a first video signal and a second video signal from a video signal conforming to a video interface mode;
a second signal selector configured to receive the path control command and the panel control command from the first interface controller, and configured to separate a first panel control command and a second panel control command from the path control command;
a driver logic unit configured to receive the first video signal and the first panel control command to drive a display panel; and
a second interface controller configured to output the second video signal and the second panel control command through a second interface mode to an external device.

13. The display driver of claim 12, wherein the second interface mode comprises a microprocessor unit (MPU) interface mode.

14. The display driver of claim 13, further comprising a buffer configured to temporarily store the second panel control command,
wherein the second interface controller outputs the second panel control command during a blanking interval of the second video signal.

15. The display driver of claim 14, wherein the blanking interval comprises a vertical blanking interval.

16. The display driver of claim 12, further comprising a video interface converter configured to convert a signal received through a third interface mode including video synchronization data to the video signal conforming to the video interface mode.

17. The display driver of claim 16, wherein the third interface mode comprises a high-speed serial interface mode including video synchronization data.

18. The display driver of claim 12, wherein the first interface mode comprises an SPI mode.

19. The display driver of claim 18, wherein the first interface controller processes the control based on an identifier of an SPI header.

20. A display driver comprising:
a first interface controller configured to receive an input video signal and a control command through a first interface mode, configured to process the control command to provide a path control command and a panel control command, and configured to convert the input video signal to a video signal conforming to a video interface mode, the video signal including video synchronization data;
a first signal selector configured to receive the path control command and the video signal from the first interface controller, and configured to separate a first video signal and a second video signal from the video signal;
a second signal selector configured to receive the path control command and the panel control command from the first interface controller, and configured to separate a first panel control command and a second panel control command from the panel control command;
a driver logic unit configured to receive the first video signal and the first panel control command to drive a display panel; and
a second interface controller configured to output the second video signal and the second panel control command through a second interface mode to an external device.

21. The display driver of claim 20, wherein the second interface mode comprises an MPU interface mode.

22. The display driver of claim 21, further comprising a buffer configured to temporarily store the second panel control command,
wherein the second interface controller outputs the second panel control command during a blanking interval of the second video signal.

23. The display driver of claim 22, wherein the blanking interval comprises a vertical blanking interval.

24. The display driver of claim 20, wherein the first interface mode comprises a high-speed serial interface mode.

25. A display device comprising:
a display panel;
a first interface controller configured to process a control command transferred through a first interface mode to provide a path control command and a panel control command;
a signal selector configured to receive the path control command from the first interface controller, and configured to separate a first video signal and a second video signal from a video signal transferred through a video interface mode;
a driver logic unit configured to receive the first video signal from the signal selector and the panel control command from the first interface controller to drive the display panel; and
a second interface controller configured to output the second video signal through a second interface to an external device.

26. The display device of claim 25, wherein the first interface controller provides the control command to the driver logic unit when the control command comprises the panel control command for controlling the driver logic unit, and configured to enable the second interface controller to output the second video signal through the video interface mode when the control command comprises the path control command for controlling an output of the second video signal.

27. The display device of claim 25, further comprising a video interface converter configured to convert a signal received through a high-speed serial interface mode including video synchronization data to the video signal conforming to the video interface mode.

28. The display device of claim 25, wherein the first interface mode comprises an SPI mode, and
wherein the first interface controller processes the control based on an identifier of an SPI header.

29. A display device comprising:
a display panel;
a first interface controller configured to receive an input video signal and a control command through a first interface mode, configured to process the control command to provide a path control command and a panel control command, and configured to convert the input video signal to a video signal conforming to a video interface mode, the video signal including video synchronization data;
a signal selector configured to receive a path control command the video signal from the first interface controller, and configured to separate a first video signal and a second video signal from the converted video signal;
a driver logic unit configured to receive the first video signal to drive the display panel using the first video signal; and
a second interface controller configured to output the second video signal through a second interface mode to an external device.

30. The display device of claim 29, wherein the first interface controller provides the control command to the driver logic unit when the control command comprises the panel control command for controlling the driver logic unit, and configured to enable the second interface controller to output the second video signal through the video interface mode when the control command comprises the path control command corresponding to an output of the second video signal.

31. The display device of claim 29, wherein the first interface mode comprises a high-speed serial interface mode including video synchronization data.

32. A display device comprising:
a display panel;
a first interface controller configured to process a control command transferred through a first interface mode to provide a path control command and a panel control command;
a first signal selector configured to receive the path control command from the first interface controller, and configured to separate a first video signal and a second video signal from a video signal conforming to a video interface mode;
a second signal selector configured to receive the path control command and the panel control command from the first interface controller, and configured to separate a first panel control command and a second panel control command from the panel control command;
a driver logic unit configured to receive the first video signal and the first panel control command to drive the display panel; and
a second interface controller configured to output the second video signal and the second panel control command through a second interface mode to an external device.

33. The display device of claim 32, further comprising a buffer configured to temporarily store the second panel control command,
wherein the second interface controller outputs the second panel control command through the MPU interface mode during a vertical blanking interval of the second video signal.

34. The display device of claim 32, further comprising a video interface converter configured to convert a signal transferred through a high-speed serial interface mode including video synchronization data to the video signal conforming to the video interface mode.

35. The display device of claim 32, wherein the first interface mode comprises an SPI mode, and
wherein the first interface controller processes the control based on an identifier of an SPI header.

36. A display device comprising:
a display panel;
a first interface controller configured to receive an input video signal and a control command through a first interface mode, configured to process the control command to provide a path control command and a panel control command, and configured to convert the input video signal to a video signal conforming to a video interface mode, the video signal including video synchronization data;
a first signal selector configured to receive the path control command and the video signal from the first interface controller, and configured to separate a first video signal and a second video signal from the converted video signal;
a second signal selector configured to receive the path control command and the panel control command from the first interface controller, and configured to separate a first panel control command and a second panel control command from the panel control command;
a driver logic unit configured to receive the first video signal the first panel control command to drive the display panel; and
a second interface controller configured to output the second video signal and the second panel control command through a second interface mode to an external device.

37. The display device of claim 36, further comprising a buffer configured to temporarily store the second panel control command,
wherein the second interface controller outputs the second panel control command through an MPU interface mode during a vertical blanking interval of the second video signal.

38. The display device of claim 36, wherein the first interface mode comprises a high-speed serial interface mode.

39. A display system comprising:
a processor configured to provide a video signal including video synchronization data, and a control command;
a first display device configured to process the control command to separate a first video signal and a second video signal from the video signal, configured to display a first video image based on the first video signal, and configured to provide the second video signal through a video interface mode; and
a second display device configured to display a second video image based on the second video signal received from the first display device.

40. The display system of claim 39, wherein the processor provides the video signal through the video interface mode and provides the control command through an SPI mode.

41. The display system of claim 39, wherein the processor provides the video signal through a high-speed serial interface mode and provides the control command through an SPI mode.

42. The display system of claim 39, wherein the processor provides the video signal and the control command through a high-speed serial interface mode.

43. A display system comprising:
a processor configured to provide a video signal including video synchronization data, and a control command;
a first display device configured to process the control command to separate a first video signal and a second video signal from the video signal, configured to display a first video image based on the first video signal and the control command corresponding to the first video signal, configured to provide the control command corresponding to the second video signal during a vertical blanking interval of the second video signal, and configured to provide the second video signal through a video interface mode; and
a second display device configured to display a second video image based on the second video signal and the control command received from the first display device.

44. The display system of claim 43, wherein the processor provides the video signal through the video interface mode and provides the control command through an SPI mode.

45. The display system of claim 43, wherein the processor provides the video signal through a high-speed serial interface mode and provides the control command through an SPI mode.

46. The display system of claim 43, wherein the processor provides the video signal and the control command through a high-speed serial interface mode.
